(19) United States
(12) Patent Application Publication
(10) Pub. No.: US 2008/0177595 A1
(43) Pub. Date: Jul. 24, 2008

(54) METHOD FOR ESTABLISHING CONSISTENCY OF PROVIDED SERVICES ACROSS GEOGRAPHIC OR CULTURAL DIFFERENCES

(75) Inventors: Syi-An ("Steven") Z. WU, Dublin, OH (US); Charles A. O'DONNELL, Westerville, OH (US); James M. BENSON, Westerville, OH (US); Scott DYSERT, Gibsonia, PA (US)

Correspondence Address: LOCKE LORD BISSELL & LIDDELL LLP;ATTN: IP DOCKETING, 600 TRAVIS STREET, 3400 CHASE TOWER, HOUSTON, TX, 77002, US

(73) Assignee: LIEBERT CORPORATION, Columbus, OH (US)

(21) Appl. No.: 11/957,193

(22) Filed: Dec. 14, 2007

Related U.S. Application Data
(60) Provisional application No. 60/886,233, filed on Jan. 23, 2007.

(51) Int. Cl. G06F 17/00

(52) U.S. Cl. 705/7

(57) ABSTRACT

A method of standardizing provided services by categorizing the provided services into one or more functional disciplines; establishing a plurality of service maturity levels for each functional discipline; establishing a plurality of service maturity criteria for each serve maturity level; assessing the service maturity level for each functional discipline according to the associated service maturity criteria; advancing to the next service maturity level when the assessment achieves a predetermined level of success.

### CROSS REFERENCE TO RELATED APPLICATIONS

This application claims benefit of and priority to U.S. provisional application Ser. No. 60/886,233, filed Jan. 23, 2007, the contents of which are incorporated herein by reference for all purposes.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to a system for standardizing provided services, and, more specifically, a process for standardizing provided services across diverse geographic boundaries and/or cultures.

2. Description of the Related Art

Multi-national companies that offer products and services in various and divergent locations and cultures have likely encountered problems and inefficiencies in providing support services to the multi-national customer base. Regional variations in how services are delivered, a diverse product base, and high growth rates in differing regions, can add to and accelerate inefficiencies and inconsistencies.

The North American model of service delivery is typically based on a field service corps of direct employees, specializing in a narrow range of products, using a consistent set of processes and tools. Furthermore, U.S.-based companies tend to think that they have the best practices and can teach other regions how to do business the “American” way. The reality may be that in order to achieve the maximum impact, a learning process is needed for everyone in the enterprise to contribute, interact, and learn from one another.

The inventions disclosed and taught herein are directed to an improved process for standardizing service across diverse geographic boundaries and/or cultures.

### BRIEF SUMMARY OF THE INVENTION

One aspect of the invention comprises a method of standardizing provided services by categorizing the provided services into one or more functional disciplines; establishing a plurality of service maturity levels for each functional discipline; establishing a plurality of service maturity criteria for each service maturity level; assessing the service maturity level for each functional discipline according to the associated service maturity criteria; and advancing to the next service maturity level when the assessment achieves a predetermined level of success.

### BRIEF DESCRIPTION OF THE SEVERAL VIEWS OF THE DRAWINGS

FIG. 1 illustrates a flow chart of the progression among varying levels of provided service maturity for the enterprise or other unit.

FIG. 2 illustrates graphically a preferred relationship among functional disciplines, maturity levels, and service criteria indicators.

### DETAILED DESCRIPTION

The Figures described above and the written description of specific structures and functions below are not presented to limit the scope of what we have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location, and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

Particular embodiments of the invention may be described below with reference to block diagrams and/or operational illustrations of methods. It will be understood that each block of the block diagrams and/or operational illustrations, and combinations of blocks in the block diagrams and/or operational illustrations, can be implemented by analog and/or digital hardware, and/or computer program instructions. Such computer program instructions may be provided to a processor of a general-purpose computer, special purpose computer, ASIC, and/or other programmable data processing system. The executed instructions may create structures and functions for implementing the actions specified in the block diagrams and/or operational illustrations. In some alternate implementations, the functions/actions/structures noted in the figures may occur out of the order noted in the block diagrams and/or operational illustrations. For example, two operations shown as occurring in succession, in fact, may be executed substantially concurrently or the operations may be executed in the reverse order, depending upon the functionality/acts/structure involved.

Computer programs for use with or by the embodiments disclosed herein may be written in an object-oriented programming language, conventional procedural programming language, or lower-level code, such as assembly language and/or microcode. The program may be executed entirely on a single processor and/or across multiple processors, as a stand-alone software package or as part of another software package.

In general, we have created a system or process for standardizing, tracking and/or improving the services provided by an enterprise across geographic and/or cultural boundaries. The system comprises categorizing the enterprises provided services into one or more functional disciplines, describing a plurality of service maturity levels for each functional discipline and developing one or more service maturity indicators or benchmarks for assessing each maturity level. Periodic assessment of each functional discipline determines whether the provided service is standardized and mature. An enterprise at a given level of maturity likely cannot benefit from advanced level of maturity until it has mastered the fundamental practices of the previous level. For example, it may not be sensible for an enterprise to develop an elaborate electronic documentation delivery system if the existing documentation does not have adequate revision controls in place. The enterprise may be organized along geographic, product, service and/or cultural differences or similarities (hereafter, generally, unit) for purposes of implementing the process.

While this process will oftentimes be implemented first in the “home” unit, such as for example, the U.S., the implementation of embodiments of this process needs to be culturally sensitive and globally relevant. It may be desirable to avoid a U.S.-centric process to make the project relevant to all international units. For example, some units may rely on distributors or service partners not employed by the enterprise to service some products, using tools and processes unique to each service provider. Further, the regional infrastructure and systems may be taken into account as some units may have to rely on local public transportation to go to the job sites.

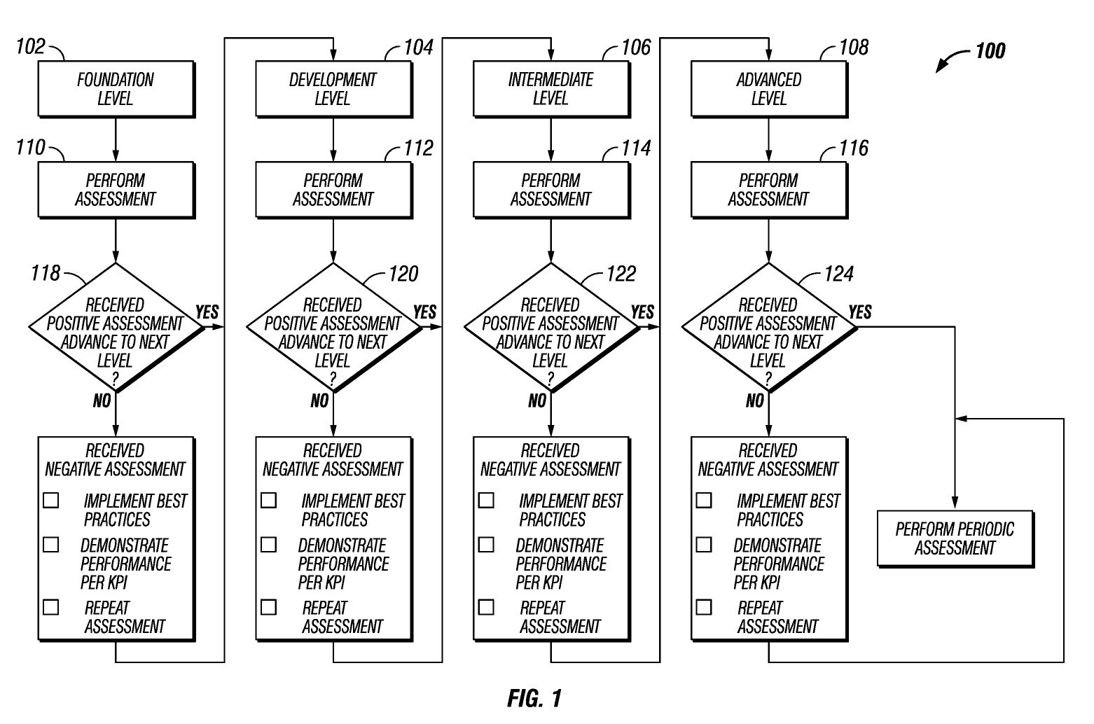

Turning now to one of numerous potential embodiments of the present invention, FIG. 1 illustrates the present invention in the form of a Service Maturity Progression flow chart 100. This flow chart illustrates that the service capability of a company, endeavor or model (hereafter, generally, enterprise) can be characterized into a plurality of levels of increasing service maturity or sophistication. In a preferred embodiment, the enterprise is characterized by four increasing service maturity levels: Foundation 102, Developing 104, Intermediate 106 and Advanced 108. As will be explained in more detail below, each service level is subject to assessment or grading 110-116 according to predetermined quantitative and/or qualitative standards. Analysis 118-124 of the assessments 110-116 are performed periodically, either randomly or scheduled, to document the enterprise's or unit's adherence to or attainment of the service maturity standards. The enterprise or unit being assessed progresses to the next level of service maturity according to the flow path established in FIG. 1. It will be appreciated that other embodiments of the invention may have more or less levels of maturity and other decision-making logic. Further, it will be understood that the process described can be implemented manually, or through existing software and services, such as conventional email, or through web or Internet-based information exchange systems.

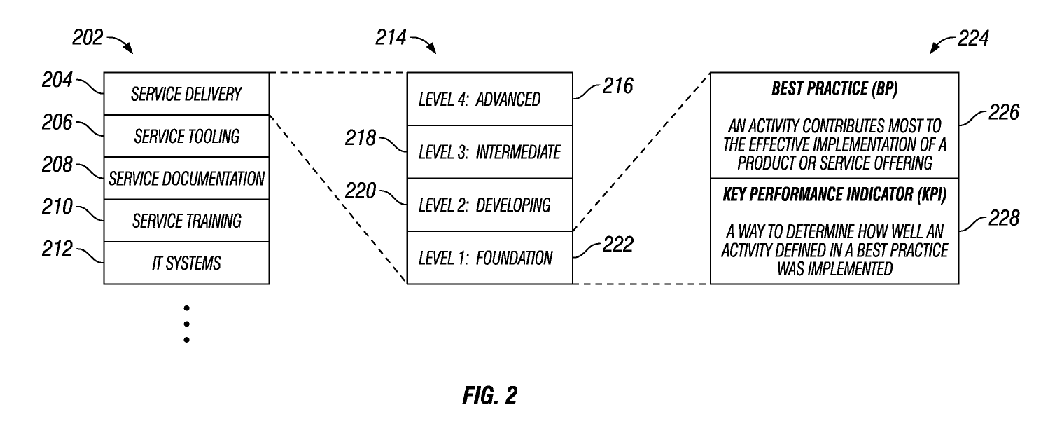

Turning to FIG. 2, it can be seen that, for example, and without limitation, the enterprise's services or operations may be categorized into one or more functional disciplines, each functional discipline may have one or more maturity level associated therewith, and each maturity level for a given functional discipline may have a set of benchmarks or service criteria associated therewith to assess or determine if the maturity level has been reached.

One embodiment of the present invention may involve a plurality of functional disciplines 202, such as Delivery 204, Tooling 206, Documentation 208, Training 210 and IT Systems 212. Each functional discipline 202 may have associated therewith a plurality of maturity levels 214, such as, without limitation, Foundation 216, Developing 218, Intermediate 220, and Advanced 222. Further, each maturity level 214 may have assigned to it a benchmark or service maturity criteria 224. For example, the embodiment illustrated in FIG. 2 utilizes Best Practices 226 and Key Performance Indicators 228 as benchmarks 224 for each maturity level 214.

As shown in FIG. 2, in such an embodiment, Best Practice 226 may define an activity or activities that contribute most to the effective implementation of an associated service offering or functional discipline 202. A Key Performance Indicator 228 may establish a way to determine how well an activity defined by the Best Practice 226 was implemented, preferably in a quantitative way, although qualitative or other non-quantitative metrics may be used.

An enterprise may develop Best Practices 226 and Key Practice Indicators 228 from years of experience. In addition, Best Practices 226 may be gathered from multiple sources such as focus groups, consulting projects, common practices, award systems such as J. D. Power, and service associations such as AFSMI.

For example, one of many Best Practice 226 for dispatching service calls to a customer may comprise responding to service requests during normal business hours, 8 hours a day, 5 days a week; responding to emergency service requests after-hours; and providing dispatching capability with escalation process for all service requests. The objective of such Service Call Best Practice may be to establish a method for dispatching service calls during normal work hours in a normal workweek.

A Service Delivery Self-Assessment Scorecard, such as shown below, may be used as a rating method to show the level of practice of Service Delivery

| Rating | Description |
|---|---|
| Red | 8 × 5 availability with no after-hours support |
| Yellow | 8 × 5 availability with limited after-hours Call |
| | Center and dispatching capability |
| Green | 8 × 5 availability with after-hours Call Center and |
| | dispatching capability that includes an escalation |
| | process |

Additional Best Practices for a Service Call may include: direct voice communication with the customer during normal business hours; a back-up receptionist (onsite or remote), including recorded voice, to handle overflow service calls; retrieval of messages every 15 minutes during normal working hours or within the first 30 minutes of the start of a new work day (if using an after-hours answering service); answering calls on 2-3 rings; dispatching service requests within 1 hour of service request; and return call service provided within 30 minute dispatch of service request.

“Revenue by Engineer” is one example of any number of Key Performance Indicators 228 that may be considered for use. Revenue by Engineer may be the average amount of revenue generated by a service Engineer each month. Service revenue may include, for example, direct or indirect revenue, by market unit, or by service offering, preventative maintenance, time and material, startup, call-out, emergency, other services. One benefit of this Key Performance Indicator is that it allows measurement of profitability, productivity, and provides a benchmark for new hires. The objective of such Key Performance Indicators may be to determine the service revenue generated per service engineer for manpower planning.

In this example, Revenue by Engineer may be calculated as the Total Monthly Service Revenue (direct or indirect) generated by the Engineers of the unit or enterprise divided by the Total number of Engineers. Data collection may include invoices by revenue segment and headcount. The unit or units of interest may report this Key Performance Indicator at a predetermined frequency such as shown below:

| | Calculate | Perform Self- |
|---|---|---|
| Gather Data | Results | Assessment |
| Quarterly | Quarterly | Annually |

As part of this Key Performance Indicator, service revenue may be set at, for example, a minimum of 3 times the service engineer's operating costs. Operating costs may include payroll, benefits, tools, communication devices, and transportation. For example, if the average cost of a Service Engineer in the field is $150,000 per year or $12,500 per month, a total yearly service revenue from an engineer of $450,000 (3 times the annual cost of the service engineer) should be expected as the performance target.

As described above for the Service Delivery Self-Assessment Scorecard, this Key Performance Indicator may use a rating method as a benchmark to show the average amount of revenue generated by the Engineers such as shown below:

| Rating | Description |
|---|---|
| Red | Do not track and/or do not possess the data or platform |
| | to track |
| Yellow | Data is accessible but not easily extracted. Limited or |
| | partial metrics exist to measure performance. |
| | Measurement baseline determined and approaching a set |
| | standard. Limited analysis and/or corrective action plans |
| Green | Fully developed system with regular analysis and |
| | corrective action plans. Measurement performance is |
| | equal to or above a set standard |

It will be understood the above examples of a Best Practice 226 and a Key Performance Indicator 228 are not limiting of the many different types of Best Practices 226 and Key Performance Indicators 228 that an enterprise will likely develop in implementing this invention.

Implementation of a system or process utilizing aspects of the present invention may be done at one time or through stages. For example, a two-stage implementation may comprise first collecting and finalizing benchmarks 224, such as Best Practices 226 and Key Practice Indicators 228 for functional disciplines 204. It is realistic to expect that between 50 and 500 benchmarks may be necessary to implement adequately a system for a multi-national enterprise. For example, we have identified 268 Best Practices 226 and Key Performance Indicators 228 for one specific enterprise.

Next, the necessary or desired maturity levels may be defined. As discussed above, the enterprise and/or unit (e.g., region or facility) needs to demonstrate that it meets the standards for the current level of maturity plus additional requirements to qualify for the next level of maturity. Thereafter, a self-assessment guide may be developed to help each region or facility conduct its own self-assessment (see, e.g., 110 FIG. 1). A form of self-assessment score card is shown below:

| | Total | |
|---|---|---|
| Level | BEST PRACTICES & | |
| of | KEY PRACTICE | Maximum |
| Maturity | INDICATORS | Scores |
| Foundation Level | 64 | 192 |
| Developing Level | 63 | 189 |
| Intermediate Level | 72 | 216 |
| Advanced Level | 69 | 207 |
| Total | 268 | 804 |

For the embodiment associated with this scorecard, each Best Practice and Key Performance Indicator is allotted a maximum of 3 points. Each audited unit may receive 3 points for mature, existing practices, 2 points for partial practices and 0 points for no existing practice.

The first stage of implementation may be completed by teams associated with each functional discipline holding regular meetings, such as voice or video conference calls to identify immediate opportunities for improved global consistency, to promote cross learning and to foster global synergies, and begin to implement programs to realize these opportunities.

The second stage of implementation may involve determining standards for each functional discipline 202 and documenting each service level criteria 224 with definition, objective, measurement, and benchmark performance. A Service Certification Audit program may be implemented. If implemented on a regional basis, for example, each region may receive a detailed post-audit report documenting findings and recommending action items for improvement. Service certificates may be presented at the global service meeting to recognize each unit's level of achievement. A form of service certificate is shown below:

| Level of Maturity | Current Level | Previous Level |
|---|---|---|
| Foundation Level | 80% | none |
| Developing Level | 80% | 90% on Foundation |
| Intermediate Level | 80% | 90% on Developing |
| Advanced Level | 80% | 90% on Intermediate |

The total points a unit achieves may be divided by the maximum points from the maturity level the unit is applying for, to obtain the percentage of attainment. A predetermined score, such as an achievement of 80%, will be the threshold to receive the certification for any maturity level. In addition, applying for certification of a maturity level beyond the first or Foundation Level may require the achievement of 90% for the previous level. For example, the criteria for achieving the Developing Level certification will require a unit to pass the 80% threshold for the Developing Level and pass the 90% threshold for the Foundation Level.

Teams associated with the functional disciplines may, and preferably should, continue to hold regular conference calls, or meetings to implement programs to improve global consistency, promote cross learning and foster global synergy. Finally, implementation of the process may be completed by establishing an oversight process of, for example, regular meetings of the service leaders and regular global service meetings.

It will be appreciated that the system described herein may be implemented as a voluntary, honest process to help each unit diagnose its operations. In such an implementation, there may be no penalty for not achieving any particular level. In fact, every region may be encouraged to be brutally honest to understand truly its level of actual maturity, not only from the common measurement but also in comparison with other units.

The self-assessment and audit process may serve as a fact-finding process for many units. With the progressive path to a higher level of maturity, a unit identifies gaps at its particular level of maturity, documents action plans to address the gaps, and progresses to the next level. Through the process, the unit may confirm either that its practices are on target or that there are gaps to be filled or better ways to perform certain practices. In addition, the post-audit report and suggested improvement areas may provide service leaders in each unit with a clear roadmap for improvement. As the process is continually employed, each unit, and therefore the global enterprise, will reap long-lasting benefits in revenue growth, cost reduction, and productivity improvement as a result of global consistency, high level of customer satisfaction, and operational management.

The process may and perhaps should be implemented with an industry specific set of criteria. Although many basic principles are the same (i.e. not industry specific), using the criteria derived from, for example, the Information Technology world for the Telecom Industry may be difficult and unrewarding. Due to the vast difference in business model, scale, requirement for response time, and service level among various industries, it is preferred to develop a specific set of criteria tailored to each industry served by the enterprise.

Other and further embodiments utilizing one or more aspects of the inventions described above can be devised without departing from the spirit of inventions disclosed and taught herein.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to protect fully all such modifications and improvements that come within the scope or range of equivalent of the following claims.

What is claimed is:

1. A method of standardizing provided services, comprising:
categorizing the provided services into one or more functional disciplines;
establishing a plurality of service maturity levels for each functional discipline;
establishing a plurality of service maturity criteria for each serve maturity level;
assessing the service maturity level for each functional discipline according to the associated service maturity criteria; and
advancing to the next service maturity level when the assessment achieves a predetermined level of success.

2. The method of claim 1, wherein the services are provided by a multi-national enterprise.

3. The method of claim 2, further comprising organizing the enterprise into a plurality of service units.

4. The method of claim 3 wherein the service units are separated geographically.

5. The method of claim 3 wherein the service units are separated culturally.

6. The method of claim 1 wherein the maturity levels comprise 4 different levels.
